(19) United States
(12) Patent Application Publication
(10) Pub. No.: US 2023/0394494 A1
(43) Pub. Date: Dec. 7, 2023

(54) SCORING ENVIRONMENTAL OFFSETS

(71) Applicant: Robert Stuart MacArthur, Cambridge, MA (US)

(72) Inventor: Robert Stuart MacArthur, Cambridge, MA (US)

(21) Appl. No.: 18/204,766

(22) Filed: Jun. 1, 2023

Related U.S. Application Data
(60) Provisional application No. 63/347,676, filed on Jun. 1, 2022.

(51) Int. Cl. G06Q 30/018

(52) U.S. Cl. CPC G06Q 30/018

(57) ABSTRACT

According to one or more embodiments herein, a system to vet and rank the value of offsets in terms of environmental (and social) benefits in simple alpha-numeric or other expressions is described. The system may provide a standardize mechanism for scoring and/or ranking offsets utilizing algorithms, analytics, metrics, and/or other means such as design elements data about each offset that is captured and stored in a matrix identifying and rating the values of various offsets over selected time frames.

### RELATED APPLICATION

This application claims priority to U.S. Prov. Appl. Ser. No. 63/347,676, filed on Jun. 1, 2022, entitled: SCORING CARBON OFFSETS, by Robert Stuart MacArthur, the contents of which are incorporated herein by reference.

### TECHNICAL FIELD

The present disclosure relates generally to environmental offsets (e.g., carbon offsets for greenhouse gas credits and allowances) and, more particularly, to an environmental benefit score for environmental offsets (e.g., a carbon offset score) to differentiate environmental benefits of such offsets.

### BACKGROUND

Pollution, emissions, global warming, and other environmental issues continue to gain media exposure and public awareness. In particular, climate change is a threat to humanity. Science has established that excessive carbon dioxide in the atmosphere is the prime cause for global warming and that carbon dioxide is a result of human activity.

Increasingly, societies worldwide are regarding a failure to reach net-zero carbon emissions expeditiously as an existential threat. As a result, carbon offset markets are expanding rapidly as a means of fighting climate change. With an increasing number of companies making such net-zero commitments and facing market scrutiny for the environmental impact of their operations, these markets are increasingly utilized to meet carbon emission goals and Environmental, Social, and Governance (ESG) standards.

A “carbon offset” refers to a reduction or removal of greenhouse gas (GHG) emissions, or an increase in carbon dioxide storage to compensate for emissions made elsewhere. A carbon offset may be instantiated in an instrument such as a credit and/or certificate. In some examples, a carbon offset may be transferable and/or tradeable. In an example, a carbon₊ offset may represent one ton of carbon dioxide and equivalent emissions (most often measured in metric tons of 2205 lbs.).

There are a variety of different types of carbon offset markets. For example, carbon offset markets may include compliance offset markets and/or voluntary offset markets.

Compliance offset markets may be created and/or regulated by mandatory national, regional, or international carbon reduction regimes. Voluntary offset markets may function outside of compliance offset markets and enable companies and/or individuals to purchase carbon offsets on a voluntary basis with no intended use for compliance purposes. While compliance offset credits may, in some instances, be purchased by voluntary, non-regulated entities, voluntary offset market credits, unless explicitly accepted into the compliance regime, may not be allowed to fulfill compliance market demand.

The voluntary offset market may be larger than the compliance offset market. Within the voluntary offset category are hundreds of different offset types derived from multitudes of projects such as forestry, agriculture, direct air capture, and sequestration.

Offsets may need to be validated and audited by independent third-party certification agencies to meet established standards, such as those of Science Based Targets. There are many third-party validators including Verry, The Gold Standard, and Green-E for RECs. The validators evaluate the claims offset developers and providers make about the legitimacy of carbon backing the offsets and publish their findings.

Offsets having varied benefits currently sell within a narrow price range, as the make-up and environmental benefits of offsets are difficult to gage and understand. Accordingly, price often dictates what most buyers purchase rather than environmental quality. This can lead to involuntary “greenwashing”—which is not the fault of the buyer but is the problem of the current system lacking uniform standards that convey the effectiveness of a given offset.

Buyers are “flying blind” in making offset purchases to address their emissions remediation objectives. This lack of information makes it difficult for buyers to understand the composition or value of offsets that they buy—thus, most elect to pay the lowest price, expecting to satisfy their ESG goals or industry requirements. They don't know and can't easily tell if their offsets will do the job of reaching their desired carbon objectives.

### SUMMARY

According to one or more embodiments of the disclosure a system to vet and/or rank the value of carbon offsets in terms of environmental benefits is described. An output of the system may include a carbon score including an alpha-numeric or other expression conveying the offsets actual benefit to the environment and/or the degree of that benefit. The system may determine a plurality of categorical attributes and/or ordinal attributes of an offset and incorporate these attributes into a score summarizing the environmental benefits of the offset.

In one particular embodiment, a computer-implemented method herein, which may be executed by one or more computer processors, may comprise: obtaining, by the one or more computer processors, an attribute set including a plurality of environmental benefit attributes associated with a particular environmental offset; calculating, by the one or more computer processors, an environmental benefit score for the particular environmental offset by executing a standardized algorithm using the attribute set; and providing, from the one or more computer processors, the environmental benefit score for the particular environmental offset to one or more processing devices that utilize environmental offsets to cause the one or more processing devices to complete one or more programmed tasks based on the environmental benefit score for the particular environmental offset.

Other embodiments may be described herein, and this summary is not meant to be limiting to the scope of the present disclosure.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates a block diagram of a system for carbon offset scoring in accordance with various embodiments herein;

FIG. 2 is a schematic block diagram of an example computing device that may be used in accordance with various embodiments herein;

FIG. 3 illustrates a carbon scoring matrix in accordance with various embodiments herein;

FIG. 4 illustrates an example simplified procedure for calculating a carbon offset score, in accordance with various embodiments herein; and

FIG. 5 illustrates an example simplified procedure for utilizing a carbon offset score, in accordance with various embodiments herein.

### DESCRIPTION OF EXAMPLE EMBODIMENTS

A carbon offset may be a substitute for GHG emission reductions that an organization would have otherwise made on its own. For this to be a true substitute, the world should be at least as well off when you use a carbon offset credit as it would have been if you had reduced your own carbon footprint directly.

When people refer to the “quality” of a carbon offset credit, they may be referring to the level of confidence that one can have that the use of the credit will fulfill this basic principle. While the concept might sound straightforward, it may be challenging to guarantee in practice. First, a quality offset credit may represent at least one metric ton of additional, permanent, and otherwise unclaimed [or avoided] CO2 emission reductions or removals. Second, a quality offset credit may come from activities that do not significantly contribute to social or environmental harms.

A variety of terms may be frequently used to define quality criteria for carbon offsets, including that associated GHG reductions must be “real,” “quantifiable,” and “verifiable.” Most of these terms have their origin in regulatory criteria established for air pollutant credits under the U.S. Clean Air Act (going back to 1977). However, these terms may have distinct regulatory meanings under U.S. law that do not always translate meaningfully to carbon offsets. The term “real,” for example, has no commonly agreed definition across carbon offset programs and standards, and is often used as a vague catch-all. In short, there is not a standardized manner by which the quality of a carbon offset is consistently judged.

As noted above, existing mechanisms fail to provide a mechanism to assess the quality of a carbon offset in a standardized, evenhanded, dependable, and quick to understand and apply format. As a result, offsets with completely different carbon reduction or avoidance values may sell for the same price, as buyers are not aware of or fully informed about their climate benefits. While third-parties are available to validate the authenticity of carbon offsets, there is no standardized scoring system and/or scoring agency ranking their worth in terms of reaching desired environmental goals or those established by the United Nations Environmental Programme (“UNEP”), the Global Compact, and/or Paris Accord.

Without such a scoring system, offset buyers now have little means of knowing the value of the offsets they buy in reporting on ESG, or to achieve carbon neutrality goals (such as net-zero); or avoiding unintended greenwashing. Imagine money lenders having no Fair Isaac way to evaluate the credit worthiness of borrowers. The same intertest rates might apply to very different risk profiles. That is what is currently going on in offset markets. The lack of such “carbon scores” as disclosed herein ultimately results in offsets of different climate remediation value all being priced about the same. For example, one offset may be tied to a metric ton of carbon removed or avoided for a given year and sell at or near the same price as one offsetting a ton each year for 20 years or more.

In short, offsets are not all created with equal values, yet all may qualify for third party accreditation and verification. This may lead to unintended greenwashing, and it may prevent buyers from assessing the risk in their offset purchases to actually achieve desired climate remediation objectives.

The techniques herein, therefore, introduce an environmental offset scoring system, particularly a carbon offset scoring system (a.k.a., CarbonScore) in certain embodiments, to vet and rank the value of offsets in terms of environmental benefits, which may, in some examples, be expressed as a simple alpha-numeric and/or other expressions. Similar to how scoring mechanisms in the financial arena are utilized by the consumer credit rating and bond rating agencies, CarbonScore may enable buyers to know what they are purchasing in terms of the offsets actually benefitting the environment and to what degree. CarbonScore may also allow accounting firms to know what they are certifying when providing certifications for carbon offsets. Currently, for the most part, accounting firms and/or other certifying agencies do not know and/or have the capability to assess these offsets. As such, these entities may actually be certifying “greenwashing” without intent. As such, CarbonScore may provide a system and/or method that can avoid aspects of greenwashing.

CarbonScore may utilize specific criteria distilled down from some core carbon offset quality markers. For example, quality carbon offset credits may be associated with carbon dioxide and/or other GHG reductions or removals may satisfy various quality criteria. For example, a quality carbon offset credit may be a credit that is additional, not over estimated, permanent, not claimed by another entity, not associated with a significant social or environmental harm, and/or is free from leakage.

A carbon offset program may be created with the intention of ensuring the quality of carbon offset credits. Many observers believe that carbon offset programs have a mixed track record. Part of the challenge may be that the quality of offset may not be black and white and/or easily ascertainable. For example, the multiple criteria involved—plus the fact that specific criteria like “additionality” are a matter of confidence rather than absolute truth— may mean that offset quality exists along a continuum. Carbon offset programs, by contrast, may be forced to make a binary decision: do they issue an offset credit or not? Most carbon offset programs may say that every credit they issue is equally valid, but suspicious buyers should feel justified in questioning this assertion. Think of scoring the quality of an offset on a 100-point scale. A carbon offset program may decide to issue credits for every GHG reduction that exceeds a score of 50. But as a buyer, is a score of 51 really “good enough”?

Astute buyers may understand this difficulty and actively seek out higher quality offset credits. For each offset quality criterion, the buyers may have additional questions about specific offset projects to better ascertain their relative quality. Even for sophisticated buyers, however, getting detailed answers to these questions may be difficult. This has led to a process to identify a range of strategies buyers can use to steer clear of lower quality offset credits and improve the chances of acquiring higher-quality credits.

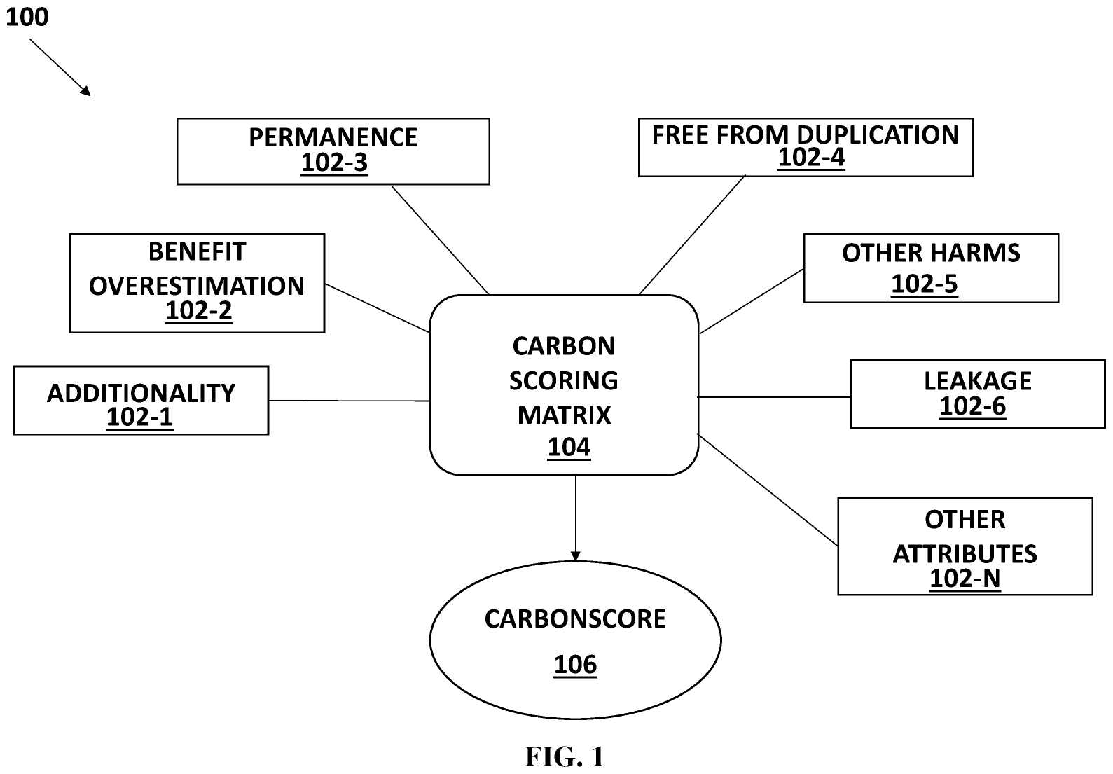

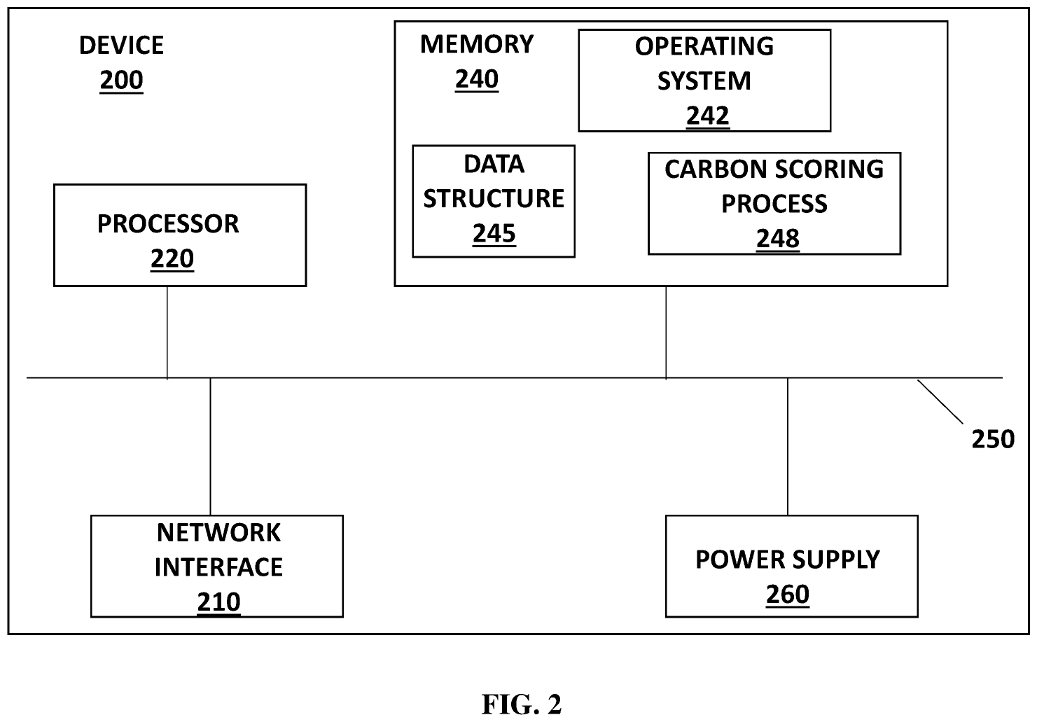

FIG. 1 illustrates a block diagram of a system 100 for carbon offset scoring in accordance with an embodiment of the invention. For example, a non-generic, specifically configured device (e.g., device 200 of FIG. 2), may provide system 100 by executing stored instructions (e.g., carbon scoring process 248 of FIG. 2).

System 100 may determine attributes 102-1 . . . 102-N of a carbon offset. Some of the attributes 102-1 . . . 102-N may be categorical attributes, such as an offset having additionality, having permanence, having leakage, being free from duplication, etc. Some of the attributes 102-1 . . . 102-N may be ordinal attributes, such as a risk and/or likelihood that the offset meets stated environmental benefits. Values of one or more categorial attributes can be changed based on a transition probability matrix and/or diagram (e.g., carbon scoring matrix 104), to evaluate and rank offsets for efficacy in reducing or avoiding carbon emissions and other GHG.

System 100 may provide a mechanism to grade all voluntary and/or compliant offsets to append environmental values. Additionally, system 100 provide a ranking system denoting the efficacy of offsets from a most beneficial to a least beneficial in terms of achieving environmental benefits.

System 100 may include a carbon scoring matrix 104 outlining the values of all the scores (e.g., ratings) assigned to offsets in various embodiments. For example, using algorithms, analytics, metrics, and/or other means (such as design elements) data about each offset may be captured and stored in carbon scoring matrix 104 identifying and rating the values of various offsets over selected time frames.

In various embodiments, carbon scoring matrix 104 may include an additionality 102-1 value assigned to an offset. For example, an offset certificate number may be appended with an “A” followed by the years of benefits ranging from 1 to 50+. Thus, an A20 score may be an offset meeting additionality criteria for a period of 20 years, whereas an A1 score is an offset meeting additionality criteria for only one year. The scoring could be arranged in reverse order such that A1 represents 50+ years of environmental benefits and A50 would represent an offset with only one year of benefit. In another example, for an offset derived from a forestry project, whereby the offset would not occur without compensating the forest owner, the owner may agree not to cut the timber for a period of 1 to 50 years (each year earning an extra point).

Carbon scoring matrix 104 may also include a benefit overestimation 102-2 value assigned to an offset. For example, this value may be indicated as an “N” for “no” or “Y” for “yes.” Therefore, an offset certificate with a score of A20N may be one meeting additionally standards for 20 years with benefits not overstated.

Additionally, carbon scoring matrix 104 may include a permanence 102-3 value assigned to an offset. For example, this designation may be a subset of the years of environmental benefits as described with respect to additionality 102-1 value. It may apply to the permanent retirement or avoidance of carbon, such as would be the case with cap-and-trade offsets that are prevented from use as permits for fossil-fueled utilities to operate for extended periods. The letter “P” can be appended to a certification.

Further, carbon scoring matrix 104 may include a free from duplication 102-4 value assigned to an offset. This value may be associated with whether a benefit associated with an offset is claimed by another entity. For example, its value may be represented by the letter “S” signifying it is single use. Thus, a designation of A20NS would denote an offset meeting additionality standards for 20 years, with no overstated claims, and/or being non-duplicative.

Furthermore, carbon scoring matrix 104 may include other harms 102-5 value assigned to an offset. This value may be associated with whether an offset is associated with and/or imposes significant social and/or environmental harms. For example, an “X” attached to a certificate number may denote the offset is free of social and environmental harms. An example of an offset associated with a social harm may include an offset involving child labor.

Additionally, carbon scoring matrix 104 may include a leakage 102-6 value assigned to an offset. This value may be associated with whether an offset is free from leakage. For example, this may be represented by the letter “F” meaning that the offset is not counter-balanced by an activity negating the environmental benefits of the offsets, such as might be the case where a forest owner agrees not to cut a specific tree-stand but then cuts a stand from another location to make up for the lost timber revenue.

Other attributes 102-N may also be used herein, as well as fewer attributes, and the attributes listed above are merely one example implementation of the techniques described herein.

In various embodiments, system 100 may include and/or compute a CarbonScore 106. CarbonScore 106 may be carbon benefit score, which may be represented as a single score summarizing a plurality of environmental benefits. Financial auditing and/or offset certifying firms may rely upon the CarbonScore 106 in certifying ESG statements and/or reports. In some examples, carbon scoring matrix 104 may include and/or be utilized to calculate CarbonScore 106.

Variations to the attributes 102-1 . . . 102-N, attribute designations, attribute values, scoring, carbon scoring matrix 104, CarbonScore 106, etc. of system 100 are additionally contemplated. The provided examples are non-limiting illustrations of potential elements of system 100.

System 100 may be operable as a carbon benefit ranking system for use by third-party offset-validators. Additionally, system 100 may be operable as a means for public and/or commercial markets to rely on the quality and/or accuracy of stated environmental benefits of offsets. System 100 may provide marketplace participants with this information that is utilizable to make informed judgements as to a market price based on values. Further, system 100 may be operable as a mechanism to track and/or monitor offsets to assure compliance to stated environmental benefits and/or to adjust the CarbonScore 106 of an offset as might be appropriate.

As such, system 100 may be a data analytics tool focused on carbon scoring services. System 100 may remedy the existing lack of environmental benefit standards backing carbon offsets and eliminate problematic climate risk analysis based on offsets without a CarbonScore 106.

The system 100 may be utilizable to evaluate individual offsets and create a numeric (or alpha-numeric) designator ranking them in terms of climate efficacy. These numbers may be appended to a carbon offset certificate, quickly denoting the degree of environmental benefits. The numeric rankings may be published data available to buyers, sellers, and/or the public as a means of understanding offset effectiveness in combating climate change. That is, system 100 may be utilizable to ensure that buyers pay for value sold while avoiding greenwashing. The system 100 may be transparent. Buyers may be able to focus on climate benefits to maximize impact per dollar spent.

System 100 may provide a specific score code identifying various levels of environmental benefits. This may enable buyers to evaluate the risks and merits of offset purchases to arrive at prices for them based on environmental impact and be able to accurately gage and represent environmental benefits in ESG statements.

Therefore, system 100 may prevent greenwashing and act as a means of accurately tracking progress toward desired environmental standards such as lowering the carbon footprint or reaching net-zero and/or carbon neutrality. Additionally, system 100 may enable offset developers and providers to price the value of their work based on environmental benefits, thus receive added revenue for premium quality offsets. Further, system 100 may reduce the risk of acquiring Offsets of little to no value in achieving climate objectives. As such, it may allow for maximizing ROI in purchasing offsets and avoid the risk of making false claims in reporting ESG or in making public announcements about them. Furthermore, system 100 may prevent auditing and public accounting individuals and firms from certifying inaccurate or false environmental benefits.

While there have been shown and described illustrative embodiments above, it is to be understood that various other adaptations and modifications may be made within the spirit and scope of the embodiments herein. For example, while certain embodiments are described herein with respect to using carbon-based pollution (e.g., carbon dioxide), the techniques are not limited as such and may be used with other pollutants or environmental assets (e.g., water conservation, waste, methane, etc.) in other embodiments.

Illustratively, the techniques described herein may be performed by hardware, software, and/or firmware, such as in accordance with a machine learning process, which may include computer executable instructions executed by a processor or plurality of processors to perform functions relating to the techniques described herein, e.g., within a single computing device or else through coordination between a plurality of computing devices across a computer network.

FIG. 2 is a schematic block diagram of an example computing device 200 that may be used with one or more embodiments described herein, e.g., as a server, personal computer, cloud computing process, datacenter, and any other computing device that supports the operations of the techniques herein. Device 200 comprises one or more network interfaces 210, one or more processors 220, and a memory 240 interconnected by a system bus 250, and is powered by a power supply 260.

The network interfaces 210 may include the mechanical, electrical, and signaling circuitry for communicating data over physical or wireless links coupled to a computer network (e.g., for determining offset attributes, communicating CarbonScores, etc.). The network interfaces may be configured to transmit and/or receive data using a variety of different communication protocols.

The memory 240 may comprise a plurality of storage locations that are addressable by the processor(s) 220 for storing software programs and data structures associated with the embodiments described herein. The processor 220 may comprise necessary elements or logic adapted to execute the software programs and manipulate the data structures 245. An operating system 242, portions of which are typically resident in memory 240 and executed by the processor(s), functionally organizes the device 200 by, among other things, invoking operations in support of software processes and/or services executing on the device 200. These software processes and/or services may comprise an illustrative “carbon scoring process” 248, configured to perform one or more aspects of the techniques as described in detail above when executed by the processor(s) 220.

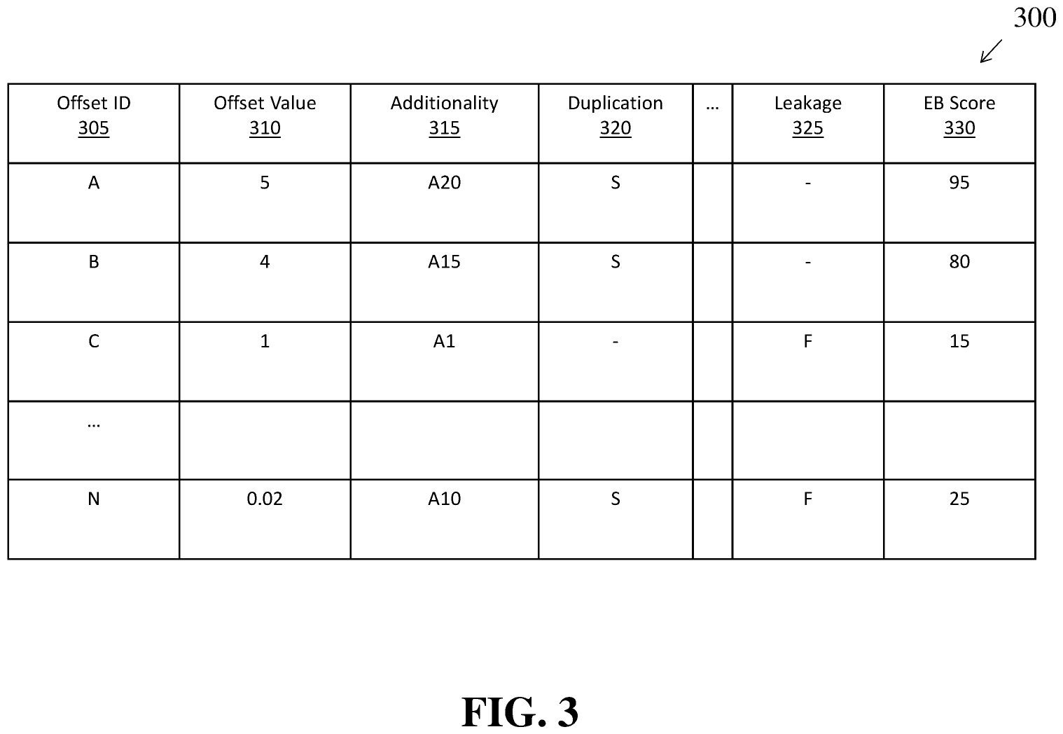

FIG. 3 illustrates an example carbon scoring matrix 300 in accordance with various embodiments herein. The carbon scoring matrix may be generated to provide a graphical representation of the environmental offset, the environmental benefit attributes and the environmental benefit scores for each offset identified simply herein as “A” through “N” (Offset ID 305), and its associated offset value 310 (e.g., in tons or other unit of measure). In accordance with one or more embodiments herein, a processor 220 may generate a representation of an evaluation matrix for storage and/or for graphical presentation on a display, such as at a user interface. A user or automated process may also input values or may obtain the values by accessing a stored database of such values. Also, in one embodiment, once one or more values have been entered into the system, whether manually or by accessing stored values, the techniques herein may optionally aggregate and/or correct the values, and may apply other adjustments as deemed necessary or beneficial, such as to account for improper scaling, fact-checking, or other scaling factors.

In this manner, the method provides an “apples-to-apples” comparison which enables the user to compare individual attribute offsets and overall scores for each entity as listed. In this sample matrix, various attributes, such as additionality 315, duplication 320, leakage 325, and others as described herein may be used to compute the Environmental Benefit (EB) score 330, which indicates the overall score for each offset listed in the matrix 300. That is, as noted above, the EB score may be generated by the algorithm that processes the environmental benefit offsets for each environmental benefit attribute to create a final EB score. Additional environmental benefit attributes may include benefit overestimation, permanence, free from duplication, and other harms, among others. A practitioner of ordinary skill in the art would note that the environmental benefit attributes listed herein is not an exhaustive list. The user may modify the environmental attributes utilized for evaluating a particular entity by adding or removing environmental benefits attributes from the algorithm. Also, the values shown and the resultant EB score are not meant to be representative of actual computation of an EB score, and are merely for purposes of discussion herein.

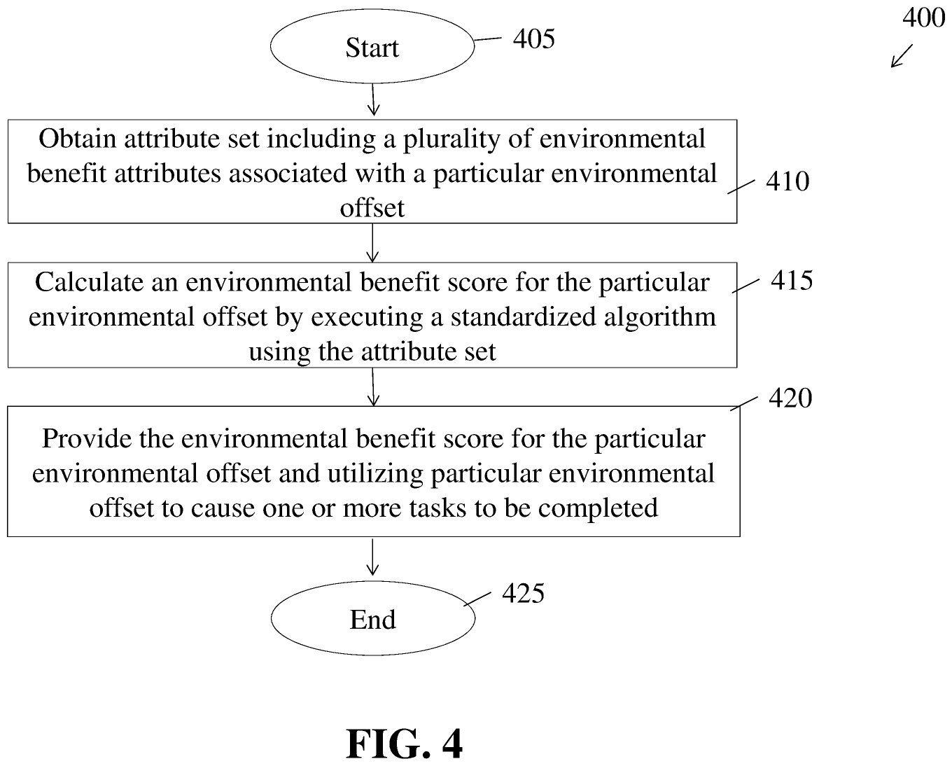

FIG. 4 illustrates an example simplified procedure 400 (e.g., a method) for scoring carbon offsets according to one or more embodiments herein. For example, a non-generic, specifically configured device (e.g., device 200 or other apparatus), may perform procedure 400 by executing stored instructions (e.g., process 248, such as a computer-implemented method, executed by one or more computer processors). The procedure 400 may start at step 405 and continue on to step 410 where, as described in greater detail above, system 100 obtains an attribute set including a plurality of environmental benefit attributes associated with a particular environmental offset. According to the embodiments herein, the particular environmental offset may correspond to one or more environmental assets selected from a group consisting of: carbon-based pollution; water conservation; material waste; and methane production; among others. Also, one or more of the environmental benefit attributes may be categorical attributes and/or ordinal attributes. In one embodiment, the one or more environmental benefit attributes may be selected from a group consisting of: additionality; permanence; leakage; duplication; overestimation; other harms; and likelihood to meet stated environmental benefits.

The procedure may continue to step 415, where system 100 may calculate an environmental benefit score for the particular environmental offset by executing a standardized algorithm using the attribute set, as described above. In one embodiment the environmental benefit score may denote the efficacy of the particular environmental offset on a scale between most beneficial and least beneficial in terms of achieving environmental benefits. In one embodiment, the one or more environmental benefit attributes may be weighted for the standardized algorithm based upon the preferences of a user, or alternatively (or in addition) based upon industry standards.

Also, in one particular embodiment, the attribute set further includes a social benefit attribute associated with a particular environmental offset, and as such the environmental benefit score may also be calculated for the particular environmental offset by executing the standardized algorithm using the attribute set including the social benefit attribute. For instance, one reason for this is that many carbon credits (which are also classified as offsets) have very high social value such as the credit being funds donated to impoverished groups and indigenous populations, or worthy causes. For instance, an offset (credit) may benefit the environment over the course of one year versus others doing so over five years, but the credit is taken by a party that is in need of money for food, education, health, etc., and thus may carry a low rank on sustainability but still be considered highly valuable in terms of social value. As such, the “environmental score” (or “CarbonScore”) herein can also be calculated to account for this, and to specifically denote this.

Note that in certain configurations, the particular environmental offset may be stored as a datum on a storage device in memory 240. As such, in one embodiment, the techniques herein may append the environmental benefit score to the stored datum, such as by generating a code representative of the environmental benefit score, and appending the code to the stored datum. As mentioned above, the code may thus identify various levels of environmental benefits associated with the particular environmental offset.

At step 420, the procedure may provide the environmental benefit score for the particular environmental offset to one or more processing devices that utilize environmental offsets to cause the one or more processing devices to complete one or more programmed tasks based on the environmental benefit score for the particular environmental offset, and the simplified procedure may end in step 425. These programmed tasks may vary depending on the requirements of the user. For example, system 100 may utilize the EB score to generate a threshold-based certification of environmental offset reports regarding the particular environmental offset; screen investments based on environmental criteria; automatically analyze ESG (Environmental, Social, and Governance) data considering environmental factors such as carbon footprint, water usage, waste management, and environmental policies; complete a smart contract (based on the score); and so on. The programmed tasks may further include acceptance of the particular environmental offset based on the environmental benefit score surpassing a particular threshold; generating sustainability rankings helping prioritize investments in companies that demonstrate strong environmental performance and sustainability practices; recommending green investment opportunities such as renewable energy projects, sustainable infrastructure development, or companies involved in environmentally friendly technologies; performing risk assessments for the entities ranked in the scoring matrix; and generating environmental performance reports for the entities ranked in scoring matrix. In another embodiment, the one or more programmed tasks may include providing marketplace participants with a display of the environmental benefit score for the particular environmental offset. In another embodiment, programmed tasks may include adjusting pricing on a point of sale device according to the environmental benefit score.

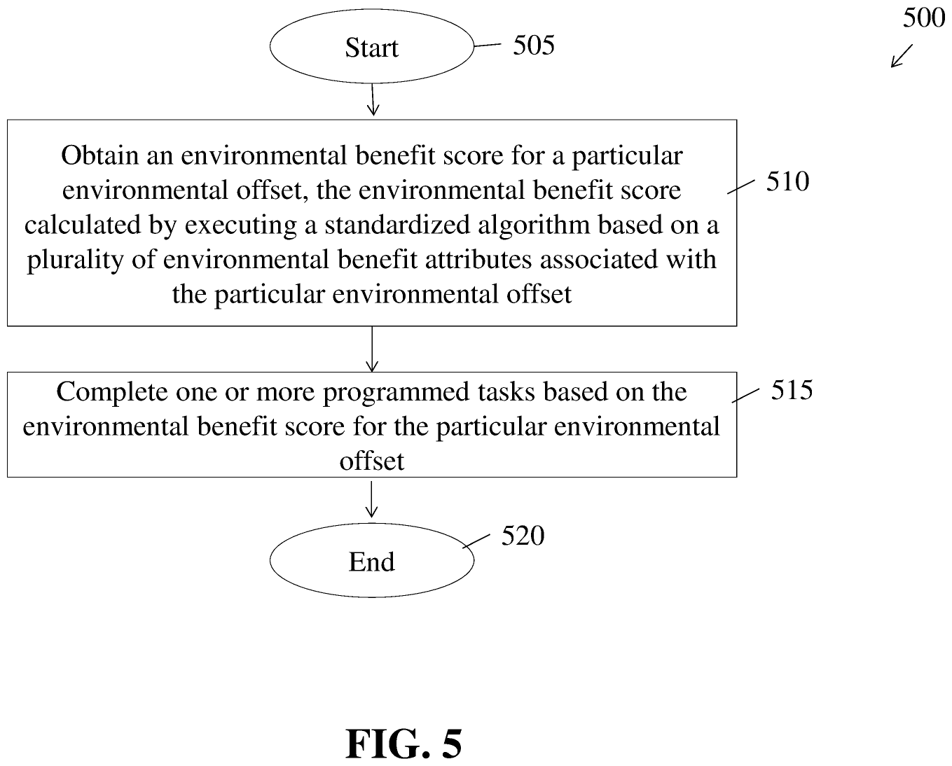

In addition, FIG. 5 illustrates another example simplified procedure 500 (e.g., a method) for utilizing carbon offset scores according to one or more embodiments herein. For example, a non-generic, specifically configured device (e.g., device 200), may perform procedure 500 by executing stored instructions (e.g., process 248). The procedure 500 may start at step 505 and continue on to step 510 where, as described in greater detail above, the device may obtain an environmental benefit score (e.g., CarbonScore) for a particular environmental offset (e.g., a carbon offset), the environmental benefit score calculated by executing a standardized algorithm based on a plurality of environmental benefit attributes associated with the particular environmental offset. In step 515, the device may then complete one or more programmed tasks based on the environmental benefit score for the particular environmental offset, such as those described above. The simplified procedure 500 may then end in step 520.

Note that in one embodiment, system 100 may track the particular environmental offset to assure compliance to stated environmental benefits; and adjust the environmental benefit score in response to the tracking, accordingly. In another embodiment, the environmental benefit score may be stored within a distributed ledger, such as a blockchain, to ensure security, chain of authority, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description to be taken only by way of example and not to otherwise limit the scope of the embodiments herein. Therefore, it is the object of the appended claims to cover all such variations and modifications as come within the true spirit and scope of the embodiments herein.

What is claimed is:

1. A computer-implemented method, executed by one or more computer processors, the computer-implemented method comprising:
obtaining, by the one or more computer processors, an attribute set including a plurality of environmental benefit attributes associated with a particular environmental offset;
calculating, by the one or more computer processors, an environmental benefit score for the particular environmental offset by executing a standardized algorithm using the attribute set; and
providing, from the one or more computer processors, the environmental benefit score for the particular environmental offset to one or more processing devices that utilize environmental offsets to cause the one or more processing devices to complete one or more programmed tasks based on the environmental benefit score for the particular environmental offset.

2. The computer-implemented method of claim 1, wherein the particular environmental offset is stored as a datum on a storage device, the computer-implemented method further comprising: appending the environmental benefit score to the datum on the storage device.

3. The computer-implemented method of claim 2, wherein appending the environmental benefit score to the datum comprises: generating a code representative of the environmental benefit score; and appending the code to the datum.

4. The computer-implemented method of claim 3, wherein the code identifies various levels of environmental benefits associated with the particular environmental offset.

5. The computer-implemented method of claim 1, wherein the one or more programmed tasks include acceptance of the particular environmental offset based on the environmental benefit score surpassing a particular threshold.

6. The computer-implemented method of claim 1, wherein the one or more programmed tasks include a threshold-based certification of environmental offset reports regarding the particular environmental offset.

7. The computer-implemented method of claim 1, wherein the one or more programmed tasks include completing a smart contract based on the environmental benefit score.

8. The computer-implemented method of claim 1, further comprising:
storing the environmental benefit score within a distributed ledger.

9. The computer-implemented method of claim 1, wherein the plurality of environmental benefit attributes consist of one or both of categorical attributes or ordinal attributes.

10. The computer-implemented method of claim 1, wherein the attribute set further includes a social benefit attribute associated with a particular environmental offset, and wherein the environmental benefit score is calculated for the particular environmental offset by executing the standardized algorithm using the attribute set including the social benefit attribute.

11. The computer-implemented method of claim 1, wherein the plurality of environmental benefit attributes are selected from a group consisting of: additionality; permanence; leakage; duplication; overestimation; other harms; and likelihood to meet stated environmental benefits.

12. The computer-implemented method of claim 1, wherein the plurality of environmental benefit attributes are weighted for the standardized algorithm based upon user preferences.

13. The computer-implemented method of claim 1, wherein the plurality of environmental benefit attributes are weighted for the standardized algorithm based upon industry standards.

14. The computer-implemented method of claim 1, wherein the one or more programmed tasks include providing marketplace participants with a display of the environmental benefit score for the particular environmental offset.

15. The computer-implemented method of claim 1, further comprising:
tracking particular environmental offset to assure compliance to stated environmental benefits; and
adjusting the environmental benefit score in response to tracking.

16. The computer-implemented method of claim 1, wherein the one or more programmed tasks include adjusting pricing on a point of sale device according to the environmental benefit score.

17. The computer-implemented method of claim 1, wherein the particular environmental offset corresponds to one or more environmental assets selected from a group consisting of: carbon-based pollution; water conservation; material waste; and methane production.

18. The computer-implemented method of claim 1, wherein the environmental benefit score denotes efficacy of the particular environmental offset on a scale between most beneficial and least beneficial in terms of achieving environmental benefits.

19. A computer-implemented method, executed by one or more computer processors, the computer-implemented method comprising:
obtaining, by the one or more computer processors, an environmental benefit score for a particular environmental offset, the environmental benefit score calculated by executing a standardized algorithm based on a plurality of environmental benefit attributes associated with the particular environmental offset; and
completing, by the one or more computer processors, one or more programmed tasks based on the environmental benefit score for the particular environmental offset.

20. An apparatus, comprising:
one or more network interfaces;
a processor coupled to the one or more network interfaces and configured to execute one or more processes; and
a memory configured to store a process that is executable by the processor, the process when executed configured to:
obtain, by the processor, an environmental benefit score for a particular environmental offset, the environmental benefit score calculated by executing a standardized algorithm based on a plurality of environmental benefit attributes associated with the particular environmental offset; and
complete, by the processor, one or more programmed tasks based on the environmental benefit score for the particular environmental offset.
